(19) United States
(12) Patent Application Publication
(10) Pub. No.: US 2010/0193442 A1
(43) Pub. Date: Aug. 5, 2010

(54) Fluidized Bed Method and Apparatus

(76) Inventors: Ian Tyler Bell, Milton (CA); Mengqi Peng, Toronto (CA); Steven Lloyd Siverns, Hamilton (CA); Frederick James Dart, Mississauga (CA)

Correspondence Address: STUART WILKINSON, 833 CALDER ROAD, MISSISSAUGA, ON, L5J 2N6, CA

(21) Appl. No.: 12/701,092

(22) Filed: Feb. 5, 2010

Related U.S. Application Data
(60) Provisional application No. 61/150,109, filed on Feb. 5, 2009.

(51) Int. Cl. B01D 24/28; C02F 1/42

(52) U.S. Cl. 210/661; 210/291; 210/137

(57) ABSTRACT

In a fluidized bed method and apparatus for stimulating reaction between a particulate reactant material and a fluid flowing through the reactant material, the incidence of coalescing of particles of the reactant material is reduced by mixing the particulate material with a particulate abrasive.

### TECHNICAL FIELD OF THE INVENTION

This invention relates to a method and apparatus for delivering fluid in which a particulate material is to be dissolved or with which a particulate material is to be reacted by passing the fluid through a mass of the particulate material with operating parameters which promote a fluidized bed of the particulate material. The method and apparatus are particularly adapted to inhibiting coalescing of the particulate material which might otherwise adversely affect the solution or reaction dynamics of the fluidized bed. The method and apparatus are particularly applicable to a water treatment technique in which water is passed through a fluidized bed of particulate zinc to promote dissolution of the zinc in the water.

### DESCRIPTION OF RELATED ART

Co-pending US Published Patent Application # 20050011839 (Water treatment apparatus and method) which is herein incorporated by reference in its entirety, describes a method of water treatment suitable for use in water circulating towers. Part of the treatment is the addition to the water of beneficial zinc. The zinc can either be added directly to the circulating water or, as described in US Patent Application Serial No. 20050011839, can be added to make-up water which is periodically added to the circulating water. The apparatus includes a canister and a feeder mechanism mounted inside the canister having a centrally mounted water inlet tube. At the bottom of the inlet tube, nozzle holes allow the escape of water flowing down the interior of the tube. A conical container extends between, and seals against, an outer surface of the inlet tube and an inner surface of the canister, and a mass of particulate zinc rests in the container. As water flows out of the inlet tube, it is directed through the mass of particulate zinc creating a scrubbing action. As a result, zinc is dissolved in the water with the rate of take up of zinc depending on the water flow rate and the amount of particulate zinc through which the water passes. These are chosen so that a desired concentration of zinc is discharged from the canister. The interior parts of the feeder mechanism are constructed and dimensioned, and the feeder mechanism is operated, so that the water flow through the zinc creates a fluidized bed ensuring that the surfaces of the zinc particles are constantly scrubbed for consistent erosion release and consistent metering of zinc into the make-up water.

If the level of scrubbing action on the particulate zinc is reduced, the rate of take-up of zinc in the make-up water is also reduced. One cause of a reduced scrubbing action is material deposition on the surface of the zinc particles. While the exact mechanism and material contributing to such deposition have not been fully determined, one contribution appears to be carbonate scale deposition acting as a cement to bind the zinc particles together. The coalescing of the zinc particles causes solid material to build up in the interior of the conical container. This, in turn, results in uneven water flow distribution, creating localized areas of high flow and low flow. In the areas of low flow, further coalescing of the zinc particles takes place, and eventually the particles in the canister may become a solid block. With no fluidization and a great reduction in surface area, zinc concentration in the discharged water falls. Another contributor to coalescing of the particulate material is the particular flow of water exiting at the nozzle holes. As described in the co-pending US Published Patent Application Serial No. 20050011839, a series of holes extend through the wall of the inlet tube, the holes being distributed around the inlet tube circumference at its lower end. Water is discharged at high speed through the holes as a series of discrete water jets, but the arrangement is susceptible to coalescing of the zinc particles at dead spots into which the jets of water do not diffuse, the dead spots located at the outer surface of the delivery tube, immediately outside of the holes.

### SUMMARY OF THE INVENTION

According to one aspect of the invention, there is provided a fluidized bed method comprising flowing fluid through a mass of particulate reactant material to promote reaction of the particulate reactant material with the fluid, and reducing incidence of coalescence of particulate reactant material by mixing the particulate reactant material with a particulate abrasive. Preferably, the particulate abrasive has a fluidization velocity generally matching that of the particulate reactant material prior to abrasion thereof. Furthermore, the particulate abrasive is substantially chemically non-reactive with the fluid, the reactant material, and any reaction products of the fluid with the reactant material. The particulate abrasive is preferably very hard and, at least in an initial stage of operation, characterized by sharp edges. The abrasive is preferably matched to the particular combination of fluid and particulate reactant material, with suitable particulate abrasives depending on the specific application and including particulate alumina, glass, sand, and steel.

For use with such a method, a fluidized bed apparatus can include a canister containing a mixture of the particulate reactant material and the abrasive, the method further comprising flowing the fluid into the canister at a lower position, flowing the fluid up through the canister to stimulate abrasion of the particulate reactant material by the particulate abrasive to thereby dissolve reactant particulate material in the fluid, and flowing the fluid out of the canister at an upper position. The method can further comprise continuing to flow the fluid through the fluidized bed over time to generate a gradation in size of abraded particulate reactant material with smaller particles of the abraded particulate reactant material generally congregating above larger particles of the abraded particulate reactant material. The method can further comprise adopting a reduced rate of fluid flow through an upper zone of the canister to limit entrainment of abraded particles within the fluid flowing out of the canister to a size of abraded particles less than a first threshold size. In one implementation, the rate of fluid flow in the upper zone is rendered less than the rate of fluid flow in a lower zone by having the mixture occupy a larger cross-sectional area in the upper zone than the cross-sectional area occupied by the mixture in the lower zone. The method can further comprise directing the fluid against a screen near the upper position, the screen acting to prevent exit from the canister of abraded particles greater than a second threshold size. To further reduce incidence of coalescence, the method can further comprise flowing the fluid into the canister through a fluid inlet means at the lower position, and configuring fluid flow from the fluid inlet means to avoid fluid streams having different flow rates through a region of the mixture immediately surrounding the fluid inlet means.

According to another aspect of the invention, there is provided fluidized bed apparatus comprising a canister containing a mixture of particulate reactant material and particulate abrasive, and a means to flow fluid through the mixture to promote reaction of the particulate reactant material with the fluid, the particulate abrasive operable to reduce incidence of coalescence of particulate reactant material. The apparatus can further comprise a governing mechanism to govern a rate of fluid flow through an upper zone of the canister thereby to limit entrainment of abraded particles within the fluid flowing out of the canister to a size of abraded particles less than a first threshold size. In one implementation, the cross sectional area of the mixture in the upper zone of the canister is greater than a cross sectional area of the mixture in a lower zone of the canister. The apparatus can further comprise a mesh screen near the upper position in the path of the fluid flow for preventing exit from the canister of abraded particles greater than a second threshold size. For further limiting the incidence of coalescence of particulate reactant material, the apparatus can include a fluid inlet means at a lower position in the canister, the fluid inlet means configured to avoid fluid streams having different flow rates through a region of the mixture immediately surrounding the fluid inlet means.

### BRIEF DESCRIPTION OF THE DRAWING

It will be appreciated that for simplicity and clarity of illustration, elements illustrated in the following FIGURE have not necessarily been drawn to scale. For example, the dimensions of some of the elements are exaggerated relative to other elements for clarity. Other advantages, features and characteristics of the present disclosure, as well as methods, operation and functions of related elements of structure, and the combinations of parts and economies of manufacture, will become apparent upon consideration of the following description and claims with reference to the accompanying drawing wherein:

FIG. 1 shows a vertical section through a canister and feed mechanism according to an embodiment of the invention.

### DETAILED DESCRIPTION OF PREFERRED EMBODIMENTS OF THE INVENTION

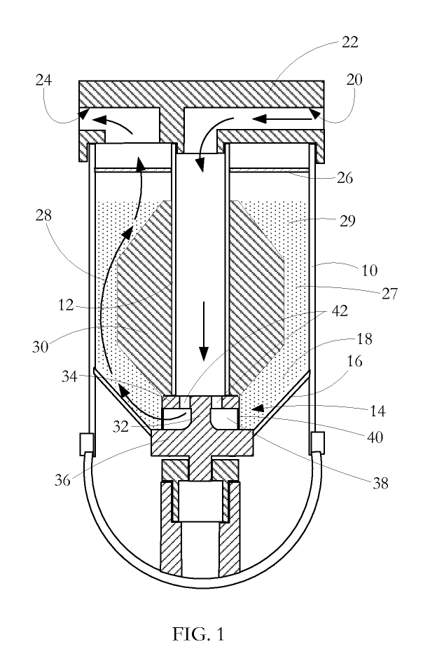

Referring in detail to FIG. 1, there is shown a feeder mechanism for adding zinc to water. The feeder mechanism is vertically mounted within a canister 10 and includes a water inlet tube 12. At the bottom of the inlet tube, a nozzle formation 14 allows the escape of water which flows down the interior of the inlet tube. A dish-form container 16 extends from the outer surface of the tube 12 to the inner surface of the canister 10 and supports a mass 18 of particulate zinc.

The container 16 is mounted so as to seal closely against an exterior surface of the inlet tube 12 and against an interior surface of the canister 10. An inlet passage 20 in a cap member 22 is in fluid communication with the inlet tube 12 and delivers feed water to the canister. Outlet passage 24 in the cap member is in fluid communication with the interior of the canister 10 and allows the feed water to flow out of the canister after flowing through the zinc. For a cooling tower arrangement, the feed water can be derived as a by-pass line from a main water line by an adjustable valve located on the main water line, the feed water being returned to the main water line after it has passed through the particulate zinc.

The action of the water flowing over the surface of the zinc particles causes a certain amount of the zinc to pass into solution in the water before it enters the outlet passage 24. The water charged with zinc is added as a metered quantity to the water circulating in a cooling tower or the like. The design and dimensions of the canister and feeder mechanism, together with the particle size and the water flow rate, are selected to promote a fluidized bed state in the particulate zinc. A fluidized bed results in self-scrubbing of the zinc particles to promote a high rate of solution of the zinc into the water.

In some circumstances, particles of zinc may coalesce and, at a high level of coalescence, the zinc may eventually form a single solid matrix. This results in an amount of zinc being taken up by the water that is substantially less than is the case when the water passes through particulate zinc. One source of solidification appears to be material build-up on the particulate zinc that can limit the number and length of water paths through the zinc and can also inhibit the direct scrubbing action that takes place when the fluidized bed is operating effectively.

To guard against coalescing of the zinc particles, in one embodiment of the invention, the zinc is mixed with a particulate abrasive such as alumina. The alumina is relatively chemically inert as well as being a hard abrasive. In one embodiment of the invention, the alumina has a particle size in the range 0.9 mm to 0.3 mm. Within the fluidized bed, the alumina acts constantly to abrade the particulate zinc. This keeps the zinc particles “clean” in the sense of continuing to present a bare zinc surface to the water flowing through the zinc. The particulate zinc and alumina have comparable fludization velocities in order that the particles mix well in the fluidized bed. Because the specific gravity of zinc (of the order of 7.1) is somewhat greater than that of alumina (of the order of 3.97), the zinc particle size selected is somewhat smaller than that of the alumina particles, although in practice a range of sizes may be preferred. It will be understood that other abrasives, including particulate glass, sand, and steel, etc., may be more appropriate in other arrangements and that mixtures of abrasives may be used to have different impact on different reactant materials where more than one particulate reactant material is being used. In addition, alternative vessel dimensions, flow rates, etc., may be adopted depending on the particular reagents (fluid and particulate material) or the particular abrading dynamics that are sought.

As shown in FIG. 1, the particulate zinc/alumina mass is contained in a chamber defined by the inner surface of the cylindrical canister 10 and the outer surface of a concentrically mounted spacer member 30. The chamber has a relatively narrow annular zone 27 which broadens into an upper zone 29. In the narrow annular zone 27, the upward velocity of the water is relatively high and so the zinc particles are agitated and subjected to the desired scrubbing and abrasive action. In the course of the scrubbing and abrading activity, smaller particles tend to migrate upwardly as shown by arrow 28. Over time, particulate material subjected to the fluidized bed motion—both zinc and alumina but particularly the softer zinc—becomes of progressively smaller particle size and, ideally, is eventually completely abraded within the chamber. In the upper zone 29, the fluid velocity reduces as a function of the increasing cross-sectional area of the zone allowing the particulate zinc to settle with smaller particles generally located higher in the zone. The water flow rate and the dimensions and operating dynamics of the fluidized bed in the upper zone 29 are chosen so that the zinc particles continue to be subjected to some abrasion and dissolution to reduce their particle size until eventually they become small enough to be driven upwardly out of the canister by the water flow, notwithstanding its lower flow velocity through the upper zone. An optional screen 26 having an aperture size of the order of 0.25 mm. can be used to prevent ejection of larger particles into the circulating water. Although in the embodiment of FIG. 1, the chamber in which the particulate material is held has an area dimension which increases progressively over the upper zone 29, it will be appreciated that the chamber can have a step transition between the lower and upper zones. In addition, whereas the variation in cross-sectional area of the zone is achieved by suitably shaping the central spacer 30, other arrangements can be adopted to the same effect. For example, the spacer can be obviated completely by having the inner form of the canister configured so as to obtain the desired variation in cross-sectional area of the chamber bounded by the canister.

To further discourage coalescing of the particulate zinc, the feeder mechanism has a modified nozzle formation. As shown in FIG. 1, a linkage element bridging the inlet tube 12 and the container 16 has a central column 32 which, together with integral upper and lower parts 34 and 36 respectively, define a generally annular chamber 38 bounded by a screen 40. The upper part 34 has apertures 42 to permit water flow from the inlet tube 12 into the chamber 38. The linkage element is shaped to redirect water flowing down through the apertures 42 into an annular flow radially outwardly from the annular chamber 38 through the screen 40 and into the zinc particles 18. With the structure shown, the water exiting the inlet tube is in the form of an annulus with the flow distributed evenly around the circumference of the tube. In this way, a relatively even pattern of water flow into the particulate zinc is established without regions of low water flow. This results in an even fluidization of the zinc in the fluidized bed to reduce the likelihood of zinc particles coalescing in comparison with the prior arrangement of discrete exit holes. In one embodiment of the invention, for water flow through zinc having a particle size in the range 0.6 mm. to 0.8 mm., the chamber has a height of the order of a centimetre and fluidization of the particulate zinc/alumina is achieved with a water flow rate of the order of 7.5 litres per minute, creating a velocity from the annular nozzle of about 0.2 metres per second and a flow velocity of about 0.035 metres per second in the lower part of the canister. Whereas a particular structure is shown as generating the desired even, annular exit flow, other structures for achieving the annular exit flow will be readily apparent to those skilled in the art. The configuration of wall elements on both the inside and outside of the structure can be selected to optimize fluid flow around the fluid inlet nozzle arrangement so as to minimize the appearance and flow rate of disparate streams. The fluid inlet nozzle is an important site in avoiding coalescence of particulate reactant material because it sets the pattern of fluid flow in the whole of the canister.

Whereas the embodiments of the invention have been described in terms of a zinc/water system, it will be appreciated that the several aspects of the invention are applicable to arrangements using a fluid other than water, including an alternative liquid or a gas. Similarly, the particulate reactant material may be a material other than zinc and the reaction dynamics sought in the fluidized bed may, in addition to material dissolution, involve more complex chemical reaction, catalytic action, etc.

What is claimed is:

1. A fluidized bed method comprising flowing fluid through a mass of particulate reactant material to promote reaction of the particulate reactant material with the fluid, and reducing incidence of coalescence of particulate reactant material by mixing the particulate reactant material with a particulate abrasive.

2. The method of claim 1, the particulate abrasive having a fluidization velocity generally matching that of the particulate reactant material prior to abrasion thereof.

3. The method of claim 1, the particulate abrasive being substantially chemically non-reactive with the fluid, the reactant material, and any reaction products of the fluid with the reactant material.

4. The method of claim 1, the particulate abrasive being hard and, at least in an initial stage of operation, characterized by sharp edges.

5. The method of claim 1, the particulate abrasive being one of alumina, glass, sand, and steel.

6. The method of claim 1, for use with fluidized bed apparatus including a canister containing a mixture of the particulate reactant material and the abrasive, the method further comprising flowing the fluid into the canister at a lower position, flowing the fluid up through the canister to stimulate abrasion of the particulate reactant material by the particulate abrasive and thereby dissolve reactant particulate material in the fluid, and flowing the fluid out of the canister at an upper position.

7. The method of claim 6, further comprising continuing to flow the fluid through the fluidized bed over time to generate a gradation in size of abraded particulate reactant material with smaller particles of the abraded particulate reactant material generally congregating above larger particles of the abraded particulate reactant material, the method further comprising adopting a rate of fluid flow through an upper zone of the canister to limit entrainment of abraded particles within the fluid flowing out of the canister to a size of abraded particles less than a first threshhold size.

8. The method of claim 7, further comprising directing the fluid against a screen near the upper position, the screen acting to prevent exit from the canister of abraded particles greater than a second threshold size.

9. The method of claim 7, further comprising limiting the rate of fluid flow in the upper zone in comparison with the rate of fluid flow in a lower zone by having the mixture occupy a larger cross sectional area in the upper zone than the cross-sectional area of the mixture in the lower zone.

10. The method of claim 6, further comprising flowing the fluid into the canister through a fluid inlet means at the lower position, and configuring fluid flow from the fluid inlet means to avoid fluid streams having different flow rates in a region of the mixture immediately surrounding the fluid inlet means.

11. A fluidized bed apparatus comprising a canister containing a mixture of particulate reactant material and particulate abrasive, and a means to flow fluid through the mixture to promote reaction of the particulate reactant material with the fluid, the particulate abrasive operable to reduce incidence of coalescence of particulate reactant material.

12. The apparatus of claim 11, the particulate abrasive having a fluidization velocity generally matching that of the particulate reactant material.

13. The apparatus of claim 11, the particulate abrasive being substantially chemically non-reactive with the fluid, the reactant material, and any reaction products of the fluid with the reactant material.

14. The apparatus of claim 11, the particulate abrasive being hard and, at least in an initial stage of operation, characterized by sharp edges.

15. The apparatus of claim 11, the particulate abrasive being one of alumina, glass, sand, and steel.

16. The apparatus of claim 11, further comprising a fluid inlet at a lower position of the canister, and a fluid outlet at an upper position of the canister.

17. The apparatus of claim 16, further comprising a governing mechanism to govern a rate of fluid flow through an upper zone of the canister thereby to limit entrainment of abraded particles within the fluid flowing out of the canister to a size of abraded particles less than a first threshhold size.

18. The apparatus of claim 16, the governing mechanism being that the cross-sectional area of the mixture as set by the form of the canister in the upper zone of the canister being greater than a cross-sectional area of the mixture as set by the form of the canister in a lower zone thereof.

19. The apparatus of claim 17, further comprising a mesh screen near the upper position in the path of the fluid flow for preventing exit from the canister of abraded particles greater than a second threshold size.
